(19) United States
(12) Patent Application Publication
(10) Pub. No.: US 2009/0153439 A1
(43) Pub. Date: Jun. 18, 2009

(54) PLASMA DISPLAY DEVICE AND PLASMA DISPLAY PANEL DRIVE METHOD

(75) Inventors: Yutaka Yoshihama, Osaka (JP); Shigeo Kigo, Osaka (JP)

Correspondence Address: RATNERPRESTIA, P.O. BOX 980, VALLEY FORGE, PA, 19482, US

(73) Assignee: Matsushita Electric Industrial Co., Ltd., Osaka (JP)

(21) Appl. No.: 12/088,750

(22) PCT Filed: Feb. 13, 2007
(86) PCT No.: PCT/JP2007/052470

§ 371 Date: Mar. 31, 2008

(30) Foreign Application Priority Data
Feb. 14, 2006 (JP) 2006-036331

(51) Int. Cl. G09G 3/28

(52) U.S. Cl. 345/60

(57) ABSTRACT

A plasma display device includes a plurality of sub fields, each sub field having an address period and a sustain period in which a sustain discharge is generated by applying a sustain pulse by the number of times corresponding to a brightness weight. A sustain pulse generating circuit has a power recovery section for raising or lowering the sustain pulse by allowing an inter-electrode capacitor of a display electrode pair including a scan electrode and a sustain electrode and an inductor to resonate and a clamp section for clamping a voltage of the sustain pulse to a predetermined voltage. The sustain pulse generating circuit sets a sustain pulse for generating a sustain discharge just before the final sustain discharge in the sustain period to a sustain pulse other than a sustain pulse having the shortest repetition period.

This application is a U.S. National Phase Application of PCT International Application PCT/JP2007/052470.

### TECHNICAL FIELD

The present invention relates to a plasma display device used in a wall-mounted television or a large-scaled monitor and to a driving method of a plasma display panel.

### BACKGROUND ART

In an AC surface discharge panel representative of a plasma display panel (hereinafter, simply referred to as “panel”), plural discharge cells are formed between a front substrate and a rear substrate opposed to each other. In the front substrate, plural display electrode pairs each including a scan electrode and a sustain electrode are on a front glass substrate to be parallel to each other and a dielectric layer and a protective layer are formed to cover the display electrode pairs. In the rear substrate, plural parallel data electrodes are formed on a rear glass substrate, a dielectric layer is formed to cover the data electrode, plural barrier ribs are formed thereon to be parallel to the data electrodes, and a fluorescent layer is formed on the surface of the dielectric layer and on the side surfaces of the barrier ribs. The front substrate and the rear substrate are opposed to each other so that the display electrode pairs and the data electrodes three-dimensionally intersect each other and are sealed in this state. For example, a discharging gas including 5% of xenon in partial pressure ratio is enclosed in an inner discharge space. Here, discharge cells are formed at positions where the display electrode pairs and the data electrodes are opposed to each other. In the panel having the above-mentioned configuration, ultraviolet rays are generated in the discharge cells by a gaseous discharge and fluorescent substances of red (R), green (G), and blue (B) are excited to emit light by the use of the ultraviolet rays, thereby performing a color display.

As a method of driving the panel, a sub filed method, that is, a method of dividing a field period into plural sub fields and performing a gray scale display by combinations of sub fields to emit light, is usually used. Each sub field includes an initializing period, an address period, and a sustain period. In the initializing period, an initializing discharge is generated, and wall charges required for a subsequent address operation are formed on the electrodes. In the address period, an address discharge is generated to form wall charges by selectively applying an address pulse voltage to the discharge cells to be displayed. In the sustain period, sustain pulses are alternately applied to the display electrode pairs each including a scan electrode and a sustain electrode, a sustain discharge is generated in the discharge cells having generated the address discharge, and the fluorescent layer of the corresponding discharge cells is made to emit light, thereby displaying an image.

In such a plasma display device, various power consumption reduction techniques have been proposed to reduce power consumption. In particular, as a technique for reducing the power consumption during the sustain period, there is disclosed a so-called power recovery circuit in which paying attention to the fact that each of the display electrode pairs is a capacitive load that has an inter-electrode capacitor, a resonance circuit having an inductor as a component is used to allow the inductor and the inter-electrode capacitor to resonate; charges accumulated in the inter-electrode capacitor is recovered by a power recovery capacitor; and the recovered charges are recycled in driving the display electrode pair (for example, see Patent Document 1).

The sub field method includes a new driving method of generating an initializing discharge by the use of a voltage waveform smoothly varying and selectively generating an initialing discharge in the discharge cells having generated the sustain discharge, thereby greatly reducing the emission of light not associated with a gray scale display to improve a contrast ratio (for example, see Patent Document 2).

Patent Document 2 discloses a so-called narrow erasing discharge in which the pulse width of the final sustain pulse in the sustain period is set to be shorter than the pulse width of the other sustain pulse so as to reduce a potential difference due to the wall charges between the display electrode pairs. By stably generating the narrow erasing discharge, it is possible to reliably perform an address operation in an address period in the subsequent sub field and thus to provide a plasma display device with a high contrast ratio.

However, with the gradual increase in screen size and precision of a panel, various techniques for increasing the brightness have been introduced. As a result, a problem of increasing the power consumption is caused, and thus a further reduction of the power consumption is requested.

Patent Document 1: Japanese Laid-Open Patent Publication No. 7-109542

Patent Document 2: Japanese Patent Unexamined Publication No. 2000-242224

### SUMMARY OF THE INVENTION

According to an aspect of the invention, there is provided a plasma display device including a plurality of discharge cells, each discharge cell having a display electrode pair formed of a scan electrode and a sustain electrode, and a field being formed of a plurality of sub fields, each sub field having an address period in which an address discharge is selectively generated in the discharge cells and a sustain period in which a sustain discharge is generated by applying a sustain pulse by the number of times corresponding to a brightness weight. The plasma display device includes: a sustain pulse generating circuit having a power recovery section for raising or lowering the sustain pulse by allowing an inter-electrode capacitor of the display electrode pair and an inductor to resonate and a clamp section for clamping a voltage of the sustain pulse to a predetermined voltage. The sustain pulse generating circuit sets a sustain pulse for generating a sustain discharge just before a final sustain discharge in the sustain period to a sustain pulse other than a sustain pulse having the shortest repetition period.

By using such a plasma display device, it is possible to reduce power consumption while increasing the brightness of a panel.

### BRIEF DESCRIPTION OF THE DRAWINGS

FIG. 1 is an exploded perspective view illustrating the structure of a panel of a plasma display device according to an embodiment of the invention.

FIG. 2 is a diagram illustrating an arrangement of electrodes of the panel of the plasma display device.

FIG. 3 is a circuit block diagram illustrating the plasma display device according to the embodiment of the invention.

FIG. 4 is a diagram illustrating driving voltage waveforms applied to the electrodes of the panel of the plasma display device according to the embodiment of the invention.

FIG. 5 is a diagram illustrating a sub field configuration in a driving method of a plasma display panel according to the embodiment of the invention.

FIG. 6 is a circuit diagram illustrating a sustain pulse generating circuit of the plasma display device according to the embodiment of the invention.

FIG. 7 is a timing diagram illustrating operations of the sustain pulse generating circuit of the plasma display device.

FIG. 8A is a diagram illustrating the relationship between the rising time of a sustain pulse and the reactive power of the sustain pulse generating circuit in the driving method of the plasma display panel according to the embodiment of the invention.

FIG. 8B is a diagram illustrating the relationship between the rising time of a sustain pulse and the light emission efficiency in the driving method of the plasma display panel according to the embodiment of the invention.

FIG. 9 is a diagram illustrating the relationship between voltage Ve1 and erasing phase difference Th1 and the rising time of the final sustain pulse in the driving method of the plasma display panel according to the embodiment of the invention.

FIG. 10 is a diagram illustrating the relationship between voltage Ve1 and the rising time of the sustain pulse just before the final sustain pulse in the driving method of the plasma display panel according to the embodiment of the invention.

FIG. 11 is a diagram illustrating the relationship between a lighting ratio and a lighting voltage in the driving method of the plasma display panel according to the embodiment of the invention, in which the repetition cycle of the sustain pulse is used as a parameter.

FIG. 12 is a diagram illustrating the relationship between the shape of the sustain pulse and APL of the plasma display device according to the embodiment of the invention.

FIG. 13 is a diagram illustrating the relationship between addressing voltage Vd and the repetition cycle and the pulse duration of the sustain pulse in the driving method of the plasma display panel according to the embodiment of the invention.

FIG. 14 is a diagram illustrating driving voltage waveforms applied to the electrodes of the panel of the plasma display device according to another embodiment of the invention.

### REFERENCE MARKS IN THE DRAWINGS

1: PLASMA DISPLAY DEVICE

10: PANEL
21: FRONT (GLASS) SUBSTRATE

22: SCAN ELECTRODE

23: SUSTAIN ELECTRODE

24, 33: DIELECTRIC LAYER

25: PROTECTIVE LAYER

28: DISPLAY ELECTRODE PAIR

31: REAR SUBSTRATE

32: DATA ELECTRODE

34: BARRIER RIB

35: FLUORESCENT LAYER

51: IMAGE SIGNAL PROCESSING CIRCUIT

52: DATA ELECTRODE DRIVING CIRCUIT

53: SCAN ELECTRODE DRIVING CIRCUIT

54: SUSTAIN ELECTRODE DRIVING CIRCUIT

55: TIMING GENERATING CIRCUIT

58: APL DETECTING CIRCUIT

100, 200: SUSTAIN PULSE GENERATING CIRCUIT

110, 210: POWER RECOVERY SECTION

120, 220: (VOLTAGE) CLAMP SECTION

### DETAILED DESCRIPTION OF PREFERRED EMBODIMENT

Hereinafter, a plasma display device according to an embodiment of the invention will be described with reference to the drawings.

### Embodiment

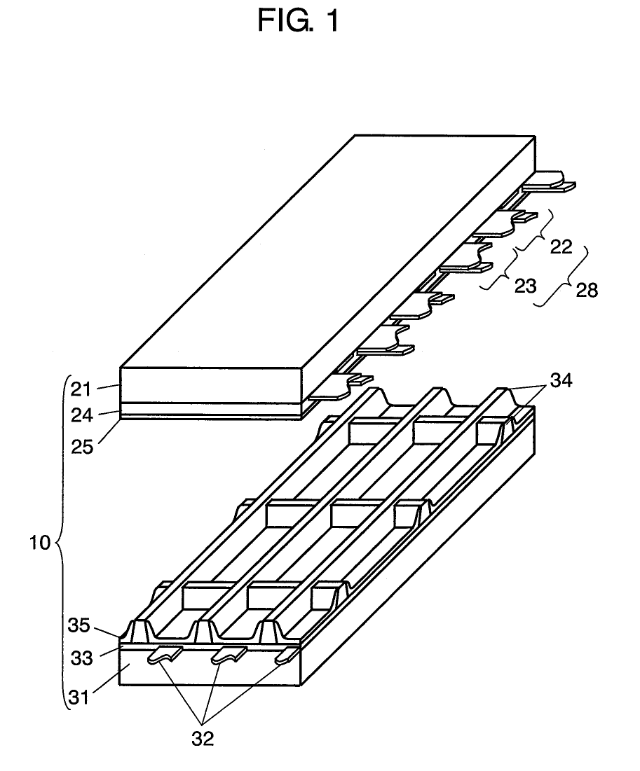

FIG. 1 is an exploded perspective view illustrating the structure of panel 10 according to the embodiment of the invention. Plural display electrode pairs 28 each having scan electrode 22 and sustain electrode 23 are formed on front glass substrate 21. Dielectric layer 24 is formed to cover scan electrodes 22 and sustain electrodes 23, and protective layer 25 is formed on dielectric layer 24. Plural data electrodes 32 are formed on rear substrate 31. Dielectric layer 33 is formed to cover data electrodes 32, and barrier ribs 34 having a mesh-shape are formed thereon. Fluorescent layer 35 emitting light of red (R), green (G), and blue (B) are formed on the side surfaces of barrier ribs 34 and on the surfaces of dielectric layer 33.

Front substrate 21 and rear substrate 31 are disposed with a minute discharge space therebetween so that display electrode pairs 28 and data electrodes 32 intersect each other and the outer circumferential portions are sealed with a sealing material such as glass frit. A mixture gas, for example, of neon and xenon is enclosed as a discharge gas in the discharge space. In the present embodiment, the discharge gas having about 10% of xenon in partial pressure is used to improve the brightness. The discharge space is partitioned into plural regions by barrier ribs 34, and discharge cells are formed at positions where display electrode pairs 28 and data electrodes 32 intersect each other. The discharge cells produce a discharge and emit light, thereby displaying an image.

The structure of the panel is not limited to the above-mentioned structure, but may have, for example, stripe-shaped barrier ribs.

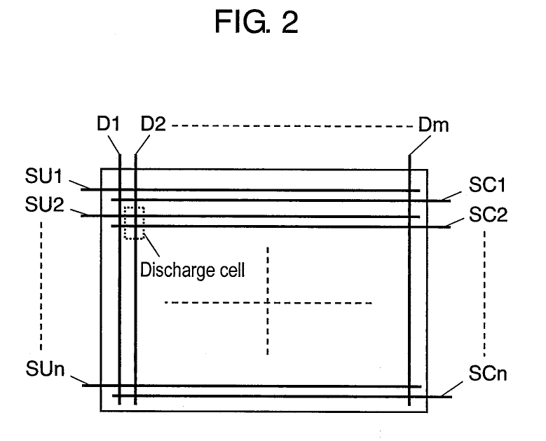

FIG. 2 is a diagram illustrating an arrangement of electrodes of panel 10 according to the embodiment of the invention. In panel 10, n scan electrodes SC1 to SCn (scan electrodes 22 in FIG. 1) and n sustain electrodes SU1 to SUn (sustain electrodes 23 in FIG. 1) which are longitudinal in the row direction are arranged and m data electrodes D1 to Dm (data electrodes 32 in FIG. 1) which are longitudinal in the column direction are arranged. A discharge cell is formed at a position where a pair of scan electrode SCi (i=1 to n) and sustain electrode SUi and one data electrode Dj (j=1 to m) intersect with each other and m×n discharge cells are formed in the discharge space in total. As shown in FIGS. 1 and 2, since scan electrode SCi and sustain electrode SUi are parallel to form a pair, a large inter-electrode capacitor Cp exist between scan electrodes SC1 to SCn and sustain electrodes SU1 to SUn.

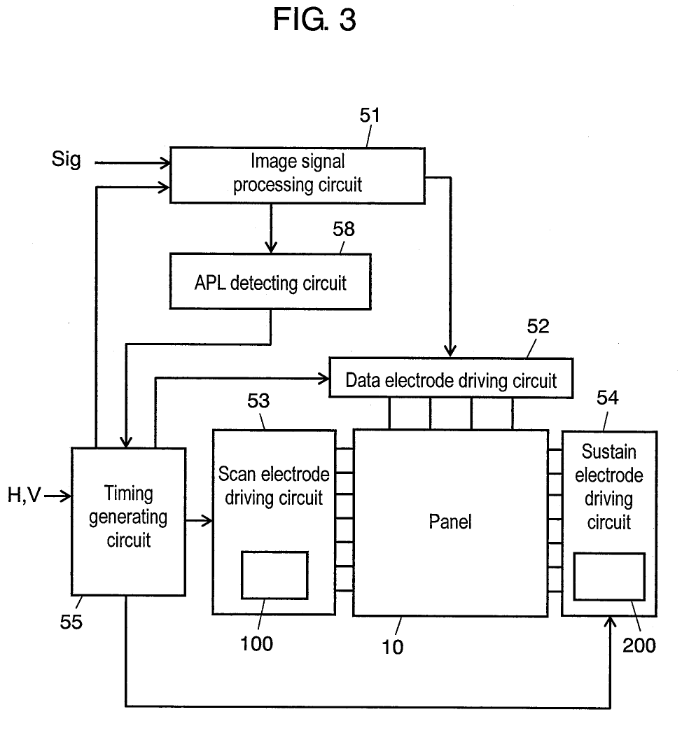

FIG. 3 is a circuit block diagram illustrating plasma display device 1 according to the embodiment of the invention. Plasma display device 1 includes panel 10, image signal processing circuit 51, data electrode driving circuit 52, scan electrode driving circuit 53, sustain electrode driving circuit 54, timing generating circuit 55, APL detecting circuit 58, and a power supply circuit (not shown) for supplying necessary power to circuit blocks.

Image signal processing circuit 51 converts input image signal Sig into image data that represents the emission or non-emission of light by sub fields. Data electrode driving circuit 52 converts the image data by sub field into signals corresponding to data electrodes D1 to Dm to drive data electrodes D1 to Dm. APL detecting circuit 58 detects an average picture level (hereinafter, simply referred to as “APL”) of image signal Sig. Specifically, the APL is detected, for example, using a generally known method of accumulating the brightness value of an image signal over one field period or one frame period.

Timing generating circuit 55 generate various timing signals for controlling operations of the circuit blocks on the basis of horizontal synchronization signal H, vertical synchronization signal V, and the APL detected by APL detecting circuit 58 and supplies the timing signals to the circuit blocks. Scan electrode driving circuit 53 includes sustain pulse generating circuit 100 for generating a sustain pulse to be applied to scan electrodes SC1 to SCn in the sustain period and drives scan electrodes SC1 to SCn on the basis of the timing signals. Sustain electrode driving circuit 54 also includes a circuit for applying voltage Ve1 to sustain electrodes SU1 to SUn in the initializing period and sustain pulse generating circuit 200 for generating a sustain pulse to be applied to sustain electrodes SU1 to SUn in the sustain period and drives sustain electrodes SU1 to SUn on the basis of the timing signals.

Next, driving voltage waveforms for driving panel 10 and operations thereof will be described now. Plasma display device 1 performs a gray-scale display by the use of a sub field method, that is, by dividing a field period into plural sub fields and controlling the emission and non-emission of light of the discharge cells by sub fields. Each sub field has an initializing period, an address period, and a sustain period. In the initializing period of each sub field, an initializing discharge is generated and wall charges required for a subsequent address discharge are formed on the electrodes. The initializing operation includes an initializing operation (hereinafter, referred to as “overall cell initializing operation”) of generating the initializing discharge in the overall discharge cells and an initializing operation (hereinafter, referred to as “selective initializing operation”) of generating the initializing discharge in the discharge cells having generated the sustain discharge in the previous sub field. In the address period, the address discharge is selectively generated in the discharge cells which should emit light, thereby forming wall charges. In the sustain period, sustain pulses of the number in proportion to a brightness weight are alternately applied to the display electrode pairs and the sustain discharge is generated in the discharge cells having generated the address discharge to emit light. Here, the proportional coefficient is called brightness magnification. The detailed configuration of the sub field will be described later, and hereinafter, the driving voltage waveforms in the sub field and the operations thereof will be described.

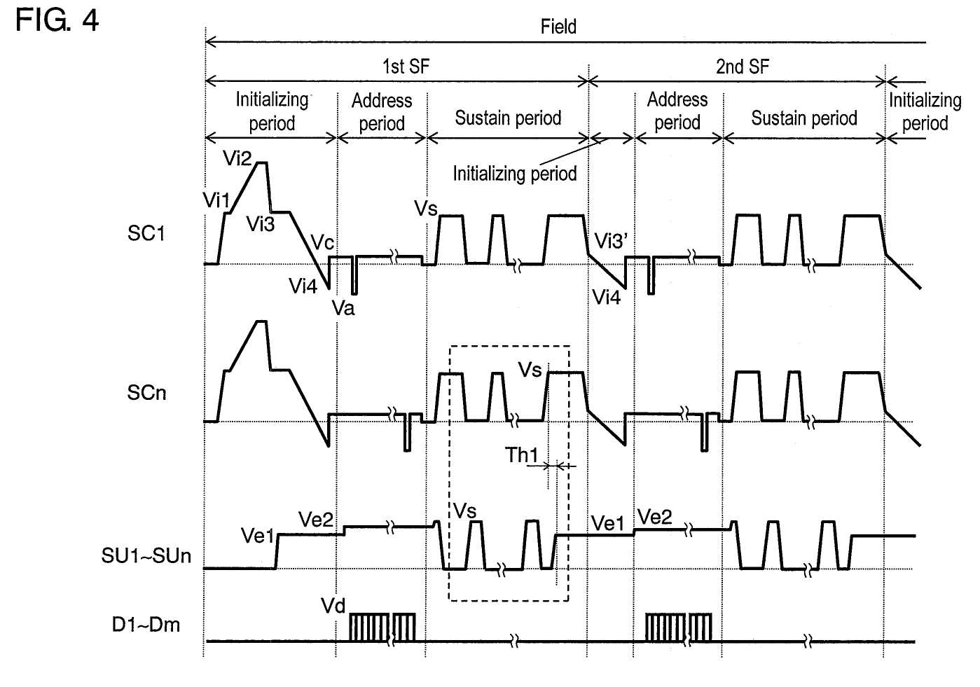

FIG. 4 is a diagram illustrating the driving voltage waveforms applied to the electrodes of panel 10 according to the embodiment of the invention. In FIG. 4, sub fields for performing the overall cell initializing operation and sub fields for performing the selective initializing operation are illustrated.

First, the sub fields for performing the overall cell initializing operation will be described.

In the first half of the initializing period, 0 V is applied to data electrodes D1 to Dm and sustain electrodes SU1 to SUn, and a ramp waveform voltage gradually rising from voltage Vi1, which is equal to or smaller than the discharge start voltage, to voltage Vi2, which is higher than the discharge start voltage, is applied to scan electrodes SC1 to SCn relative to sustain electrodes SU1 to SUn. Then, a weak initializing discharge is generated between scan electrodes SC1 to SCn, sustain electrodes SU1 to SUn, and data electrodes D1 to Dm during the rising of the ramp waveform voltage. In this case, negative wall voltages are formed on scan electrodes SC1 to SCn, and positive wall voltages are formed on data electrodes D1 to Dm and on sustain electrodes SU1 to SUn. Here, the wall voltages on the electrodes means voltages resulting from the wall charges accumulated on the dielectric layers, the protective layers, or the fluorescent layers, which cover the electrodes.

Subsequently, in the second half of the initializing period, positive voltage Ve1 is applied to sustain electrodes SU1 to SUn, and a ramp waveform voltage (hereinafter, referred to as “ramp voltage”) gradually falling from voltage V13, which is equal to or smaller than the discharge start voltage, to voltage V14, which is higher than the discharge start voltage, is applied to scan electrodes SC1 to SCn relative to sustain electrodes SU1 to SUn. During this period, a weak initializing discharge is generated between scan electrodes SC1 to SCn, sustain electrodes SU1 to SUn, and data electrodes D1 to Dm. In this case, the negative wall voltage on scan electrodes SC1 to SCn and the positive wall voltage on sustain electrodes SU1 to SUn are weakened, whereby the positive wall voltage on data electrodes D1 to Dm are adjusted to a value suitable for the address operation. In this way, the overall cell initializing operation of generating the initializing discharge in the overall discharge cells is finished.

In the subsequent address period, voltage Ve2 is applied to sustain electrodes SU1 to SUn, and voltage Vc is applied to scan electrodes SC1 to SCn. Next, negative scan pulse voltage Va is applied to first scan electrode SC1 and positive address pulse voltage Vd is applied to data electrodes Dk (k=1 to m) of the discharge cells which should emit light in the first row among data electrodes D1 to Dm. At this time, a voltage difference of an intersection between data electrode Dk and scan electrode SC1 is obtained by adding the difference between the wall voltage of data electrode Dk and the wall voltage of scan electrode SC1 to externally applied voltage difference (Vd−Va), and exceeds the discharge start voltage. The address discharge is generated between data electrode Dk and scan electrode SC1 and between sustain electrode SU1 and scan electrode SC1, a positive wall voltage is formed on scan electrode SC1 of the discharge cell, a negative wall voltage is formed on sustain electrode SU1, and a negative wall voltage is formed on the data electrode Dk. In this way, the address operation of causing the address discharge in the discharge cells which should emit light in the first row and accumulating wall voltages on the electrodes is performed. On the other hand, since voltages of intersections between data electrodes D1 to Dm not supplied with address pulse voltage Vd and scan electrode SC1 do not exceed the discharge start voltage, the address discharge is not generated. By performing the address operation up to the n-th row discharge cells, the address period is finished.

In the subsequent sustain period, a power recovery circuit is used to reduce power consumption. Details of the driving voltage waveforms will be described later, and hereinafter, the summary of the sustain operation in the sustain period will be described. First, positive sustain pulse voltage Vs is applied to scan electrodes SC1 to SCn and 0 V is applied to sustain electrodes SU1 to SUn. Then, in the discharge cells having generated the address discharge, the voltage difference between scan electrode SCi and sustain electrode SUi is obtained by adding the difference between the wall voltage on scan electrode SCi and the wall voltage on sustain electrode SUi to sustain pulse voltage Vs and thus exceeds the discharge start voltage. The sustain discharge is generated between scan electrode SCi and sustain electrode SUi, and fluorescent layer 35 emits light due to the ultraviolet rays created at that time. A negative wall voltage is formed on scan electrode SCi and a positive wall voltage is formed on sustain electrode SUi. A positive wall voltage is formed on data electrode Dk. In the discharge cells not having generated the address discharge in the address period, the sustain discharge is not generated and the wall voltage at the end of the initializing period is maintained.

Subsequently, 0 V is applied to scan electrodes SC1 to SCn and sustain pulse voltage Vs is applied to sustain electrodes SU1 to SUn. Then, in the discharge cells having generated the sustain discharge, since the voltage difference between sustain electrode SUi and scan electrode SCi exceeds the discharge start voltage, the sustain discharge is generated again between sustain electrode SUi and scan electrode SCi, whereby a negative wall voltage is formed on sustain electrode SUi and a positive wall voltage is formed on scan electrode SCi. Thereafter, similarly, by alternately applying sustain pulses of the number corresponding to the brightness weights multiplied by a brightness magnification to scan electrodes SC1 to SCn and sustain electrodes SU1 to SUn to apply a potential difference between the electrodes of the display electrode pairs, the sustain discharge is continuously generated in the discharge cells having generated the address discharge in the address period.

At the last of the sustain period, by applying a potential difference of a so-called narrow pulse shape between scan electrodes SC1 to SCn and sustain electrodes SU1 to SUn, the wall voltage on scan electrode SCi and sustain electrode SUi are erased in a state where positive wall charges are left on data electrodes Dk. Specifically, sustain electrodes SU1 to SUn are first returned to 0 V, and thereafter, sustain pulse voltage Vs is applied to scan electrodes SC1 to SCn. Then, in the discharge cells having generated the sustain discharge, the sustain discharge is generated between sustain electrode SUi and scan electrode SCi. Before the discharge converges, that is, while charge particles created due to the discharge sufficiently remain in the discharge space, voltage Ve1 is applied to sustain electrodes SU1 to SUn. Accordingly, the voltage difference between sustain electrode SUi and scan electrode SCi is weakened to about (Vs−Ve1). Then, in a state where positive wall charges are left on data electrode Dk, the wall voltage between scan electrodes SC1 to SCn and sustain electrodes SU1 to SUn is weakened to about the difference (Vs−Ve1) of voltages applied to the electrodes. Hereinafter, this discharge is referred to as “erasing discharge.”

In this way, in a predetermined time interval (hereinafter, referred to as “erasing phase difference Th1”) after voltage Vs for generating the final sustain discharge, that is, the erasing discharge, is applied to scan electrodes SC1 to SCn, voltage Ve1 for reducing the potential difference between the electrodes of the display electrode pairs to sustain electrodes SU1 to SUn. In this way, the sustain operation in the sustain period is finished.

Next, the operations in the sub field for performing the selective initializing operation will be described.

In the initializing period for performing the selective initializing operation, voltage Ve1 is applied to sustain electrodes SU1 to SUn and 0 V is applied to data electrodes D1 to Dm, respectively, and a ramp voltage gradually falling from voltage Vi3′ to voltage Vi4 is applied to scan electrodes SC1 to SCn. Then, in the discharge cells having generating the sustain discharge in the sustain period of the previous sub field, a weak initializing discharge is generated and the wall voltages on scan electrode SCi and sustain electrode SUi are weakened. In data electrode Dk, since the positive wall voltage is sufficiently formed on data electrode Dk by the previous sustain discharge, the excessive wall voltage is discharged and thus the wall voltage is adjusted to be suitable for the address operation. On the other hand, in the discharge cells not having generated the sustain discharge in the previous sub field, the discharge is not generated and the wall charges at the end of the initializing period of the previous sub field are maintained. In this way, the selective initializing operation is an operation of selectively generating the initializing discharge in the discharge cells having generated the sustain operation in the sustain period of the previous sub field.

The operation of the subsequent address period is equal to that of the address period of the sub field for performing the overall cell initializing operation and thus descriptions thereof will be omitted. The operation of the subsequent sustain period is equal to that of the sustain period, except for the number of sustain pulses.

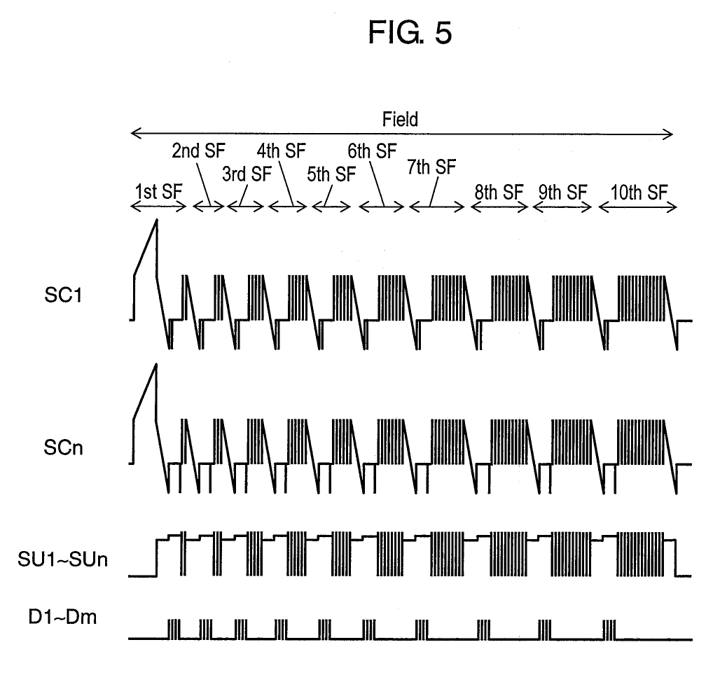

Next, the configuration of the subfields will be described. FIG. 5 is a diagram illustrating the configuration of the sub fields according to the embodiment of the invention. In the present embodiment, one field includes 10 sub fields (1st SF, 2nd SF, . . . , 10th SF) and the sub fields have brightness weights of, for example, 1, 2, 3, 6, 11, 18, 30, 44, 60, and 80. The overall cell initializing operation is performed in the initializing period of the 1st SF and the selective initializing operation is performed in the initializing periods of the second SF to the 10th SF. In the sustain periods of the sub fields, the sustain pulses corresponding to the number obtained by multiplying the brightness weights of the sub fields by a predetermined brightness magnification are applied to display electrode pairs.

However, in the first embodiment, the number of sub fields or the brightness weights of the sub fields are not limited to the above-mentioned values, but the configuration of the sub fields may be changed on the basis of the image signals or the like.

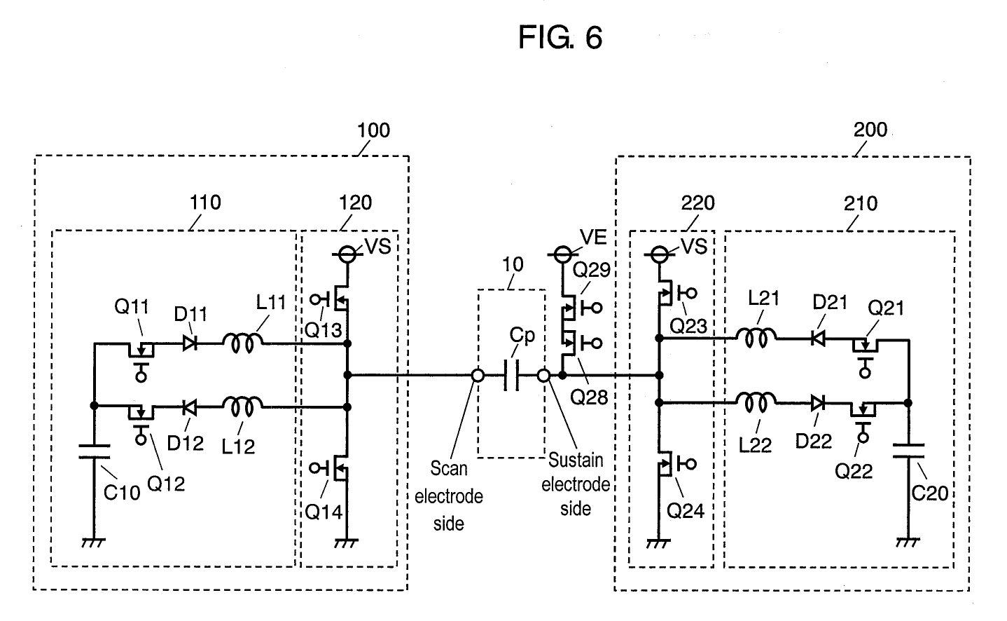

Next, details of sustain pulse generating circuits 100 and 200 and the operations thereof will be described. FIG. 6 is a circuit diagram of sustain pulse generating circuit 100 and sustain pulse generating circuit 200 according to the embodiment of the invention. In FIG. 6, an inter-electrode capacitor of panel 10 is represented by Cp, and circuits for generating the scan pulses and the initialization voltage waveforms are not illustrated.

Sustain pulse generating circuit 100 includes power recovery section 110 and clamp section 120. Power recovery section 110 includes power recovery capacitor C10, switching element Q11 and switching element Q12, reverse-current preventing diode D11 and reverse-current preventing diode D12, and resonating inductor L11 and resonating inductor L12. Clamp section 120 includes switching element Q13 and switching element Q14. Power recovery section 110 and clamp section 120 are connected to scan electrodes 22 which are ends of inter-electrode capacitors Cp via the scan pulse generating circuit, which is not illustrated because it is short-circuited in the sustain period. The inductance of inductor L11 and inductor L12 is set so that the resonant cycle of inter-electrode capacitor Cp is longer than the pulse duration of the sustain pulse. Here, the resonant cycle means a cycle of the LC resonance. For example, when the inductance of an inductor is L and the capacitance of a capacitor is C, the resonant cycle can be calculated by a formula “2π(LC)^{1/2}.” Here, inductance L is the inductance of inductor L11 or inductor L12, and capacitance C is inter-electrode capacitor Cp of panel 10.

Power recovery section 110 raises and lowers the sustain pulses by allowing inter-electrode capacitor Cp and inductor L11 or inductor L12 to resonate. During the rising of the sustain pulse, charges accumulated on power recovery capacitor C10 are moved to inter-electrode capacitor Cp via switching element Q11, diode D11, and inductor L11. During the falling of the sustain pulse, charges accumulated on inter-electrode capacitor Cp are moved to power recovery capacitor C10 via inductor L12, diode D12, and switching element Q12. In this way, the sustain pulses are applied to scan electrode 22. Accordingly, power recovery section 110 drives scan electrode 22 by the LC resonance without power supplied from the power source, so theoretically, the power consumption becomes 0. Power recovery capacitor C10 has a capacitance sufficiently larger than that of inter-electrode capacitor Cp and is charged to about Vs/2, half of voltage Vs of power source VS so as to function as a power source of power recovery section 110. Since the impedance of power recovery section 110 is high, when a strong sustain discharge is generated in a state where scan electrode 22 is driven by power recovery section 110, the voltage applied to scan electrode 22 is greatly lowered by the discharge current. However, in the present embodiment, during a period in which scan electrode 22 is driven by power recovery section 110, the sustain discharge is not generated. Even when the sustain discharge is generated, the voltage value of power source VS is set to a low value so that the generated sustain discharge does not cause the voltage applied to scan electrode 22 to be greatly lowered by the discharge current.

Voltage clamp section 120 connects scan electrode 22 to power source VS via switching element Q13 to clamp scan electrode 22 to voltage Vs and connects scan electrode 22 to the ground via switching element Q14 to clamp scan electrode 22 to 0 V. In this way, voltage clamp section 120 drives scan electrode 22. Accordingly, the impedance during application of voltage by voltage clamp section 120 is small, and it is thus possible to stably flow a large discharge current by a strong sustain discharge.

In this way, sustain pulse generating circuit 100 applies sustain pulses to scan electrode 22 using power recovery section 110 and voltage clamp section 120 by controlling switching element Q11, switching element Q12, switching element Q13, and switching element Q14. These switching elements can be configured using generally known elements such as MOSFET or IGBT.

Sustain pulse generating circuit 200 includes power recovery section 210 having power recovery capacitor C20, switching element Q21, switching element Q22, reverse-current preventing diode D21, reverse-current preventing diode D22, resonating inductor L21, resonating inductor L22, and clamp section 220 having switching element Q23 and switching element Q24 and is connected to sustain electrode 23, an end of inter-electrode capacitor Cp of panel 10. The operations of sustain pulse generating circuit 200 is equal to those of sustain pulse generating circuit 100, and thus descriptions thereof will be omitted. The inductance of inductor L21 and inductor L22 is set so that the resonant cycle of inter-electrode capacitor Cp is longer than the pulse duration of the sustain pulse.

In FIG. 6, power source VE for generating voltage Ve1 for reducing the potential difference between electrodes of the display electrode pairs and switching element Q28 and switching element Q29 for applying voltage Ve1 to sustain electrode 23 are illustrated, and operations thereof will be described later.

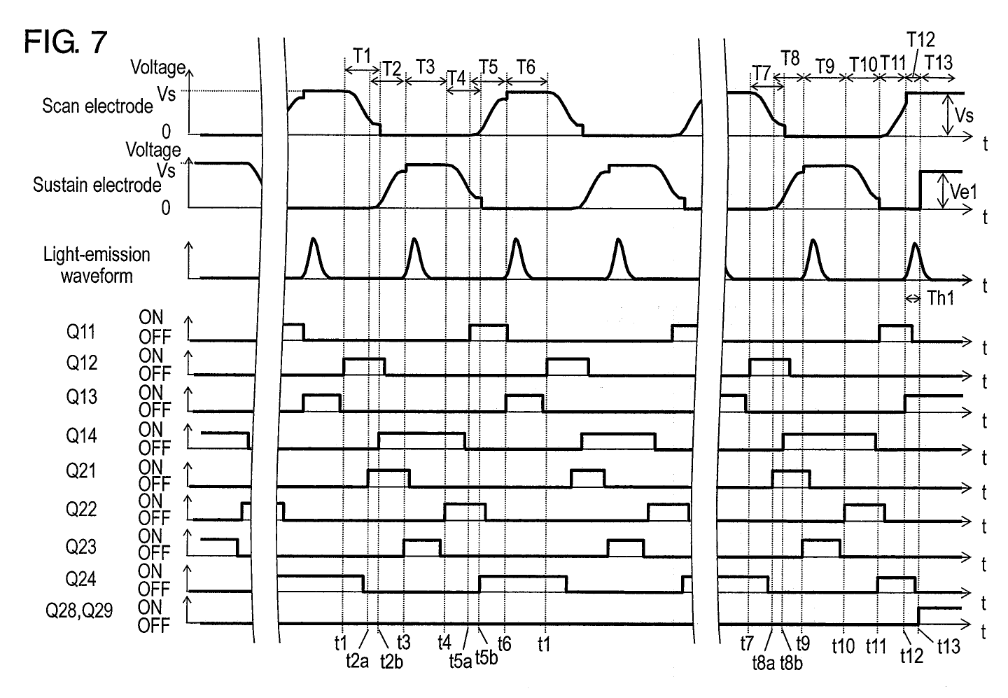

Next, the operations of the sustain pulse generating circuit and the details of the sustain pulses will be described. FIG. 7 is a timing diagram illustrating operations of sustain pulse generating circuit 100 and sustain pulse generating circuit 200 according to the embodiment of the invention. One cycle of the repetition cycle of the sustain pulse is divided into six periods of T1 to T6 and then the respective periods will be described. Hereinafter, an operation of turning on a switching element will be denoted by “ON,” and an operation of turning off a switching element will be denoted by “OFF.” The repetition period of the sustain pulse means a gap between sustain pulses repeatedly applied to the display electrode pairs in the sustain period and means a period in which time periods T1 to T6 are repeated. In FIG. 7, a positive waveform is used to describe but the invention is not limited to this. For example, although the example of a negative waveform is not illustrated, the same effect can be achieved for the negative waveform by reading an expression, “rise,” in connection with the positive waveform in the following descriptions as “fall” in the description of the negative waveform.

### (Period T1)

At time point t1, switching element Q12 is turned ON. Then, current starts flowing from scan electrode 22 to capacitor C10 via inductor L12, diode D12, and switching element Q12 so the voltage of scan electrode 22 starts going down. In the present embodiment, since the resonant cycle of inductor L12 and inter-electrode capacitor Cp is set to 2000 nsec, the voltage of scan electrode 22 goes down to about 0 V after 1000 nsec from time point t1. However, because period T1 from time point t1 to time point t2b, that is, the length of time for lowering a sustain pulse using power recovery section 110 is set to a range from 650 nsec to 850 nsec, shorter than 1000 nsec, based on APL, the voltage of scan electrode 22 does not go down to 0 V at time point t2b. At time point t2b, switching element Q14 is turned ON. Then, since scan electrode 22 is directly grounded via switching element Q14, the voltage of scan electrode 22 is clamped to 0 V.

Switching element Q24 is ON, and sustain electrode 23 is clamped to 0 V. Immediately before time point t2a, switching element Q24 that clamps sustain electrode 23 to 0 V is turned OFF.

### (Period T2)

At time point t2a, switching element Q21 is turned ON. Then, current starts flowing from power recovery capacitor C20 to sustain electrode 23 via switching element Q21, diode D21, and inductor L21 so the voltage of sustain electrode 23 starts going up. Since the resonant cycle of inductor L21 and inter-electrode capacitor Cp is set to 2000 nsec, the voltage of sustain electrode 23 goes up to about Vs after 1000 nsec from time point t2a. However, because period T2 from time point t2a to time point t3, that is, the length of time for raising a sustain pulse using power recovery section 210 is set to 900 nsec, the voltage of sustain electrode 23 does not go up to Vs at time point t3. At time point t3, switching element Q23 is turned ON. Then, since sustain electrode 23 is directly connected to power source VS via switching element Q23, the voltage of sustain electrode 23 is clamped to Vs.

In the present embodiment, a period in which period T1 and period T2 overlap with each other. Hereinafter, this period, that is, a period from time point t2a to time point t2b will be referred to as “overlap period.” The length of this overlap period is set to a range from 250 nsec to 450 nsec, based on APL. In the present embodiment, by providing such an overlap period, a repetition cycle of the sustain pulse is reduced.

### (Period T3)

When sustain electrode 23 is clamped to Vs, in discharge cells in which an address discharge is generated, the voltage difference between scan electrode 22 and sustain electrode 23 exceeds a discharge start voltage so a sustain discharge is generated. Immediately before time point t4, switching element Q23 that clamps sustain electrode 23 to Vs is turned OFF.

In this way, during period T3, the voltage of sustain electrode 23 is maintained at sustain pulse voltage Vs, and the length of period T3 is a pulse duration of the sustain pulse applied to sustain electrode 23. The pulse duration means a length of time during which the voltage of the sustain pulse raised by resonance is clamped to Vs and additionally is maintained at Vs for a predetermined length of time. In the present embodiment, period T3 is set to a range from 850 nsec to 1250 nsec, based on APL.

Switching element Q12 may be turned OFF during a period from time point t2b to time point t5a, and switching element Q21 may be turned OFF during a period from time point t3 to time point t4.

### (Period T4)

At time point t4, switching element Q22 is turned ON. Then, current starts flowing from sustain electrode 23 to power recovery capacitor C20 via inductor L22, diode D22, and switching element Q22 so the voltage of sustain electrode 23 starts going down. The resonant cycle of inductor L22 and inter-electrode capacitor Cp is set to 2000 nsec, and period T4 from time point t4 to time point t5b, that is, the length of time for raising a sustain pulse using power recovery section 210 is set to a range from 650 nsec to 850 nsec, based on APL. Therefore, the voltage of sustain electrode 23 does not go down to 0 V at time point t5b.

At time point t5b, switching element Q24 is turned ON. Then, since sustain electrode 23 is directly grounded via switching element Q24, the voltage of sustain electrode 23 is clamped to 0 V. Immediately before time point t5a, switching element Q14 that clamps scan electrode 22 to 0 V is turned OFF.

### (Period T5)

At time point t5a, switching element Q11 is turned ON. Then, current starts flowing from power recovery capacitor C10 to scan electrode 22 via switching element Q11, diode D11, and inductor L11 so the voltage of scan electrode 22 starts going up. The resonant cycle of inductor L11 and inter-electrode capacitor Cp is set to 2000 nsec, and the length of time for lowering a sustain pulse using power recovery section 110 is set to 900 nsec. Therefore, the voltage of scan electrode 22 does not go up to Vs at time point t6. At time point t6, switching element Q13 is turned ON. Then, the voltage of scan electrode 22 is clamped to Vs.

In the present embodiment, a period in which period T4 and period T5 overlap with each other. Hereinafter, this period, that is, a period from time point t5a to time point t5b will be also referred to as “overlap period.” The length of this overlap period is also set to a range from 250 nsec to 450 nsec, based on APL.

### (Period T6)

When scan electrode 22 is clamped to Vs, in discharge cells in which an address discharge is generated, the voltage difference between scan electrode 22 and sustain electrode 23 exceeds the discharge start voltage so a sustain discharge is generated.

In this way, during period T6, the voltage of scan electrode 22 is maintained at sustain pulse voltage Vs, and the length of period T6 is a pulse duration of the sustain pulse applied to scan electrode 22. In the present embodiment, period T6 is also set to a range from 850 nsec to 1250 nsec, based on APL.

Switching element Q22 may be turned OFF during a period from time point t5b to time point t2a in a subsequent sustain pulse repetition cycle, and switching element Q11 may be turned OFF during a period from time point t6 to time point t1 in a subsequent sustain pulse repetition cycle. To reduce the output impedance of sustain pulse generating circuit 100 and sustain pulse generating circuit 200, it is preferable to turn OFF switching element Q24 immediately before time point t2a in the subsequent sustain pulse repetition cycle and to turn OFF switching element Q13 immediately before time point t1 in the subsequent sustain pulse repetition cycle.

By repeating the above operations of periods T1 to T6, sustain pulse generating circuit 100 and sustain pulse generating circuit 200 of the present embodiment can apply a necessary number of sustain pulses to scan electrode 22 and sustain electrode 23.

As described in subtitles Period T1 to Period T6, in the present embodiment, the resonant cycle of inductor L11 (or inductor L21) and inter-electrode capacitor Cp is set so as to be longer than the pulse duration of the sustain pulse, i.e., longer than the length of period T3 and period T6. The length of time twice the length of time for raising the sustain pulse using power recovery section 110 and power recovery section 210, i.e., twice the length of period T2 and period T5 is set so as to be longer than the length of period T3 and period T6. By setting in such a way, the reactive power (power that is consumed without contributing to light-emission) of sustain pulse generating circuit 100 and sustain pulse generating circuit 200 is reduced, thus improving the light emission efficiency (light emission intensity to power consumption). The reason will be described.

To investigate the relationship between the resonant cycle of power recovery section 110 and power recovery section 210 and the reactive power and the light emission efficiency, the present inventors measured the reactive power and the light emission efficiency while varying the resonant cycle of power recovery section 110 and power recovery section 210. The present inventors conducted experiment by setting the rising time of the sustain pulse to half of the resonant cycle of power recovery section 110 and power recovery section 210. In this way, for example, when the resonant cycle of power recovery section 110 and power recovery section 210 is set to 1200 nsec, the rising time is set to 600 nsec, while when the resonant cycle is set to 1600 nsec, the rising time is set to 800 nsec.

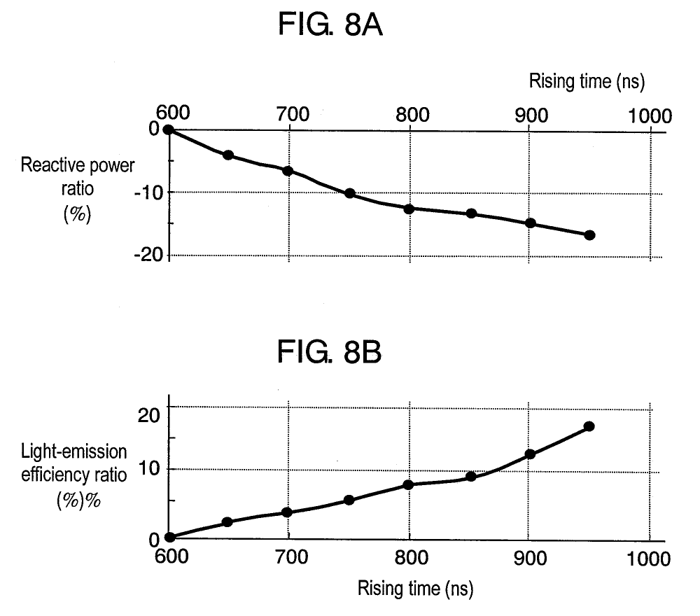

FIG. 8A is a diagram showing the relationship between the rising time of the sustain pulse and the reactive power of the sustain pulse generating circuit according to the present embodiment, and FIG. 8B is a diagram showing the relationship between the rising time and the light emission efficiency. In FIGS. 8A and 8B, the reactive power and light emission efficiency are illustrated as a percentage value, in which their values become 100 when the rising time is set to 600 nsec. The vertical axis in FIG. 8A represents a reactive power ratio, the vertical axis in FIG. 8B represent a light emission efficiency ratio, and the horizontal axes in FIGS. 8A and 8B represent a rising time.

For this experiment, it can be known that by increasing the rising time, the reactive power of sustain pulse generating circuit 100 and sustain pulse generating circuit 200 is reduced. As shown in FIG. 8A, for example, by varying the rising time from 600 nsec to 750 nsec, the reactive power is reduced by about 10%; by varying to 900 nsec, the reactive power is reduced by about 15%. In addition, it can be known that by increasing the rising time, the light emission efficiency is also improved. As shown in FIG. 8B, by varying the rising time from 600 nsec to 750 nsec, the light emission efficiency is improved by about 5%; by varying to 900 nsec, the light emission efficiency is improved by about 13%.

In this way, it is confirmed from the experiment that by smoothing the rise of the sustain pulse to 750 nsec or more, preferably 900 nsec or more, the reactive power of sustain pulse generating circuit 100 and sustain pulse generating circuit 200 is reduced and the light emission efficiency of the sustain discharge is also improved.

In the above-described driving method, if the pulse duration of the sustain pulse is too short, the wall voltage formed accompanied by the sustain discharge becomes insufficient, and thus it is difficult to continuously generate the sustain discharge. To the contrary, if the pulse duration of the sustain pulse is too long, the repetition cycle of the sustain pulse becomes long, and thus it is difficult to apply a necessary number of sustain pulses to a display electrode pair. For this reason, practically, it is preferable to set the pulse duration of the sustain pulse to a range from about 800 nsec to about 1500 nsec. In the present embodiment, the length of period T3 and period T6 corresponding to the pulse duration of the sustain pulse is set to a time length ranging from 850 nsec to 1250 nsec so that a sufficient wall voltage can be formed and a necessary number of sustain pulses can be secured.

In view of these conditions, it can be known that by setting the length of time twice the length of time for raising the sustain pulse using power recovery section 110 and power recovery sections 210, i.e., twice the length of period T2 and period T5 so as to be longer than the pulse duration of the sustain pulse, i.e., longer than the length of period T3 and period T6, it is possible to provide the advantage of reducing the reactive power and improving the light emission efficiency. More preferably, the rising time of the sustain pulse is set so as to be longer than the length of period T3 and period T6. By setting the resonant cycle of inductor L11 (or inductor L21) and inter-electrode capacitor Cp so as to be longer than twice the rising time of the sustain pulse, i.e., than twice the length of period T2 and period T5, it is possible to prevent the lowering of the voltage applied to the display electrode pair during the rising time of the sustain pulse, i.e., during period T2 and period T5. Accordingly, by setting the resonant cycle so as to be longer than the pulse duration of the sustain pulse, i.e., than the length of period T3 and period T6, it is possible to provide the advantage of reducing the reactive power and improving the light emission efficiency. More preferably, the length of time 0.5 to 0.75 times the resonant cycle is set so as to be longer than the length of period T3 and period T6.

The repetition cycle of the sustain pulse includes, as one cycle, period T1 to period T6. In the present embodiment, by providing an overlap period from time point t2a to time point t2b, in which period T1 and period T2 overlap with each other, and an overlap period from time point t5a to t5b, in which period T4 and period T5 overlap with each other, the repetition cycle of the sustain pulse is reduced by the length of these overlap periods. As a result, the driving time for one field is reduced, and the number of sustain pulses can be increased by increasing a brightness magnification by making the most of the reduced driving time, thereby increasing a peak brightness of a display image.

Sustain pulse generating circuit 100 and sustain pulse generating circuit 200 according to the present embodiment are independently provided with inductor L11 and inductor L21 that determine the resonant cycle of the rising of the sustain pulse and inductor L12 and inductor L22 that determine the resonant cycle of the falling of the sustain pulse. For this reason, when varying the rising time or falling time of the sustain pulse, it is possible to cope with various specifications of a panel while varying the values of inductor L11 and inductor L21 or inductor L12 and inductor L22. In particular, as described above, when increasing the rising time to smooth the rise of the sustain pulse, it is preferable to independently set the resonant cycle of the rising of the sustain pulse and the resonant cycle of lowering the sustain pulse. By independently providing inductor L11 and inductor L21 and inductor L12 and inductor L22 to power recovery section 110 and power recovery section 210, the amount of heat emitted from one inductor can be reduced by half, thereby providing the advantage of reducing the thermal resistance of the inductor.

In the above descriptions, the difference between the rising time and falling time of the sustain pulse is not large. For this reason, the resonant cycle of the rising of the sustain pulse and the resonant cycle of the falling of the sustain pulse in power recovery section 110 and power recovery section 210 are set to the same value, and inductor L11 and inductor L21, inductor L12 and inductor L22 have the same inductance.

Next, a detailed operation when giving a potential difference for generating an erasing discharge between electrodes of the display electrode pair will be described. Period T7, period T8, period T9, and period T10 in FIG. 7 are the same as the above-described period T1, period T2, period T3, and period T4, and thus descriptions thereof will be omitted.

### (Period T11)

At time point t11, switching element Q11 is turned ON. Then, current starts flowing from power recovery capacitor C10 to scan electrode 22 via switching element Q11, diode D11, and inductor L11 so the voltage of scan electrode 22 starts going up. In the present embodiment, period T11 from time point t11 to time point t12, that is, the rising time of the final sustain pulse in the sustain period is set to 650 nsec, and the rising time (period T2 and period T5) of the remaining sustain pulses is set shorter than 900 nsec. At time point t12 before the voltage of scan electrode 22 goes up to the vicinity of Vs, switching element Q13 is turned ON. Then, scan electrode 22 is directly connected to power source VS via switching element Q13 and is thus clamped to Vs.

### (Period T12)

When the voltage of scan electrode 22 goes up steeply to Vs, in discharge cells in which a sustain discharge is generated, the voltage difference between scan electrode 22 and sustain electrode 23 exceeds a discharge start voltage so a sustain discharge is generated. Immediately before time point t13, switching element Q24 that clamps sustain electrode 23 to 0 V is turned OFF.

### (Period T13)

At time point t13, switching element Q28 and switching element Q29 are turned ON. Then, since sustain electrode 23 is directly connected to erasing power source VE via switching element Q28 and switching element Q29, the voltage of sustain electrode 23 goes up steeply to Ve1. Time point t13 is a time point before the sustain discharge generated in period T12 converges, i.e., a time point at which charge particles created due to the sustain discharge sufficiently remain in the discharge space. Since an electric field in the discharge space varies during a period in which the charge particles sufficiently remain in the discharge space, the charge particles are rearranged to reduce the varied electric field, whereby the wall charges are formed.

At that time, since the difference between voltage Vs applied to scan electrode 22 and voltage Ve1 applied to sustain electrode 23 is small, the wall voltages on scan electrode 22 and sustain electrode 23 are weakened. In this way, the time interval from time point t12 to time point t13, i.e., period T12 is a time interval from the application time of voltage Vs for generating the final sustain discharge to the application time of voltage Ve1. By applying voltage Ve1 to sustain electrode 23 before the final sustain discharge converges, the potential difference between electrodes of the display electrode pair is reduced. That is, the phase difference between the application time of voltage Vs for generating the final sustain discharge to scan electrode 22 and the application time of voltage Ve1 to sustain electrode 23 has a narrow-width pulse shape, and the pulse width corresponds to erasing phase difference Th1. The sustain discharge generated in the last period corresponds to a discharge called an erasing discharge. At this time, since data electrode 32 is kept at 0 V and the charge particles created due to a discharge form wall charges so as to reduce the potential difference between the voltage applied to data electrode 32 and the voltage applied to scan electrode 22, a positive wall voltage is formed on data electrode 32.

Since the potential difference of a narrow-width pulse shape applied to the discharge cells is practically applied via switching elements, although, strictly speaking, there is a possibility that the erasing phase difference is not equal to the time interval from time point t12 to time point 13, it can be thought that the time interval is substantially equal to erasing phase difference Th1 as long as there is not great difference in the delay time of the switching elements. In the present embodiment, the length of period T12, i.e., erasing phase difference Th1 is set to 350 nsec. The length of period T11, i.e., the length of the rising time of the final sustain pulse in the sustain period is set to 650 nsec, shorter than 900 nsec, which is the length of period T2 and period T5, i.e., the length of the rising time of the other sustain pulses.

As described in subtitles Period T11 to Period T13, the reasons the erasing phase difference Th1 is set to 350 nsec and the rising time of the final sustain pulse in the sustain period is set to 650 nsec, shorter than the rising time of the other sustain pulses will be described.

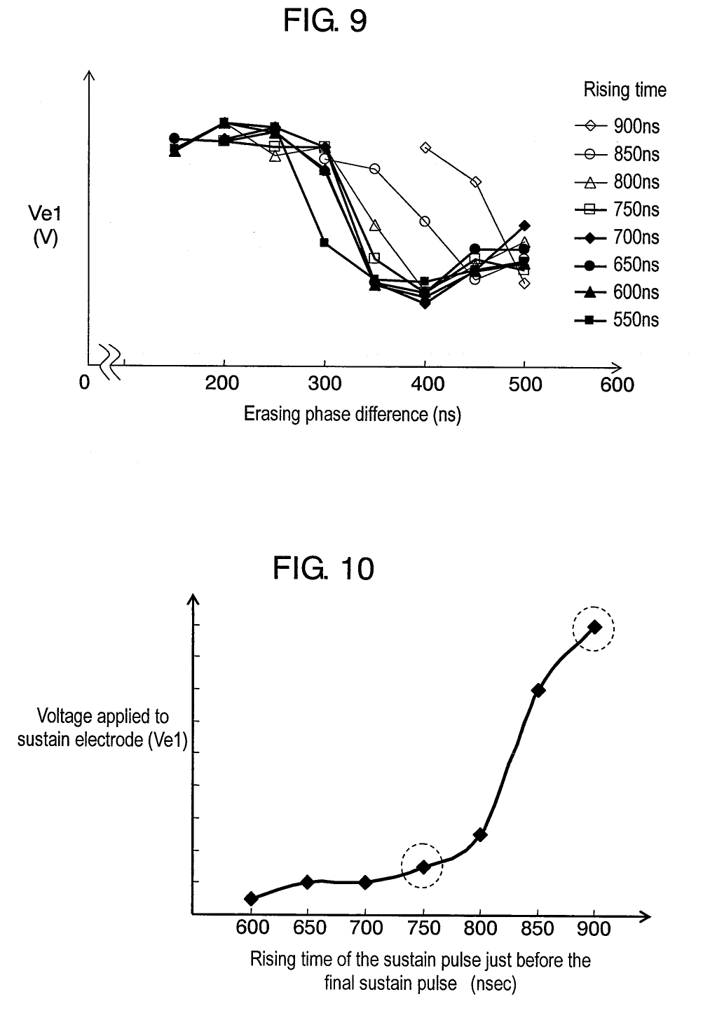

The present inventors conducted experiment to investigate the relationship between the erasing phase difference Th1 and the rising time of the final sustain pulse and application voltage Ve1 to sustain electrode 23 in the initializing period. When application voltage Ve1 to sustain electrode 23 is too high, there is a possibility that an address discharge is generated in discharge cells to which address pulses are not applied. Therefore, it is preferable to lower the application voltage to increase a driving margin. FIG. 9 is a diagram illustrating the relationship between voltage Ve1 required for performing a normal selective initializing operation in the initializing period and erasing phase difference Th1 and the rising time of the final sustain pulse, in which the horizontal axis represents erasing phase difference Th1 and the vertical axis represents voltage Ve1. As a result of the experiment, it can be known that by setting the rising time of the final sustain pulse to 800 nsec or less and setting erasing phase difference Th1 to not less than 350 nsec and not more than 400 nsec, it is possible to lower voltage Ve1 required for performing a normal selective initializing operation. In the present embodiment, based the experiment results, erasing phase difference Th1 is set to 350 nsec and the rising time of the final sustain pulse is set to 650 nsec. With this configuration, voltage Ve1 applied to the sustain electrode is lowered to increase a driving margin during the address operation, thereby realizing a stable initializing discharge and a stable address discharge.

The present inventors found from experiment that by setting the rising time of the sustain pulse just before the final sustain period, i.e., period T8 in FIG. 7 so as to be shorter than 900 nsec, it is possible to further lower voltage Ve1 required for performing a normal selective initializing operation. FIG. 10 is a diagram illustrating the relationship between the rising time of the sustain pulse just before the final sustain pulse and voltage Ve1, in which the horizontal axis represents the rising time of the sustain pulse just before the final sustain pulse and the vertical axis represents voltage Ve1. As a result of the experiment, it can be found that by setting the rising time of the sustain pulse just before the final sustain pulse to 800 nsec or less, it is possible to lower voltage Ve1. At the same time, it has been found that when the rising time was set much shorter, voltage Ve1 does not change much. In the present embodiment, considering utilization efficiency of the recovered power, the rising time of the sustain pulse just before the final sustain pulse is set to 750 nsec. With such a configuration, application voltage Ve1 to the sustain electrode required for generating a normal initializing discharge is further lowered, thus realizing a further increase in the driving margin.

Next, the present inventors conducted experiment to investigate the relationship between the ratio (hereinafter, simply referred to as “lighting ratio”) of the number of discharge cells having generated the sustain discharge to the total number of discharge cells and the repetition cycle of the sustain pulse and a sustain pulse application voltage (hereinafter, simply referred to as “lighting voltage”) required for generating the sustain discharge.

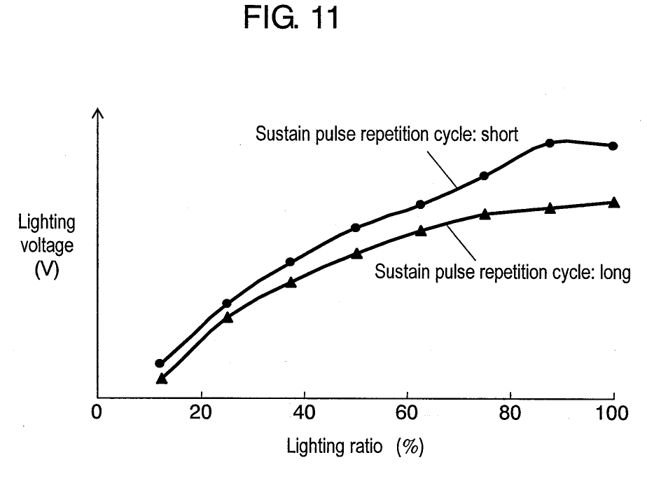

FIG. 11 is a diagram illustrating the relationship between the lighting ratio and the lighting voltage according to the present embodiment, in which the repetition cycle of the sustain pulse is used as a parameter. The vertical axis represents the lighting voltage, and the horizontal axis represents the lighting ratio. The repetition cycle of the sustain pulse is 3.8 μsec and 4.8 μsec. Form the experiment, it can be known that the lighting voltage falls when the lighting ratio is low while the lighting voltage rises when the lighting ratio is high. It can be known that the lighting voltage rises as the repetition cycle of the sustain pulse decreases while the lighting voltage falls as the repetition cycle of the sustain pulse increases.

The reason the lighting voltage rises as the lighting ratio increases can be thought that for example, when the lighting ratio increases, the discharge current increases to increase the amount of voltage drop caused by capacitive components of the display electrode pair, lowering the voltage applied between the display electrode pairs of the discharge cell, whereby the lighting voltage increases seemingly. The reason the lighting voltage rises as the repetition cycle of the sustain pulse can be thought that when the repetition cycle of the sustain pulse decreases, the pulse duration of the sustain pulse also decreases to decrease the wall voltage formed accompanied by the sustain discharge, whereby the sustain pulse voltage applied to the display electrode pairs is increased by that much.

In general, in the case of displaying an image having a low APL, the lighting ratio of the sub field having a large brightness weight is low. Therefore, the lighting voltage is also lowered as described above. This means that when displaying an image having a low APL, it is possible to reduce the repetition cycle of the sustain pulse of the sub field having a large brightness weight.

In the present embodiment, when displaying an image having a low APL, the pulse duration of a sustain pulse of a sub field having a large brightness weigh is reduced. In the present embodiment, when displaying an image having a low APL, by increasing an overlap period in which the rise and fall of the sustain pulse overlap with each other and decreasing the falling time of the sustain pulse, the repetition cycle of the sustain pulse is further reduced. However, when the overlap period of the sustain pulse is excessively increased or when the falling time of the sustain pulse is excessively decreased, the reactive power is likely to increase. In the present embodiment, considering the discharging characteristics of a panel and the irregularity or the like, the overlap period of the sustain pulse is set to a range from 250 nsec to 450 nsec and the falling time of the sustain pulse is set to a range from 650 nsec to 850 nsec. Additionally, by making the most of the reduced driving time, the brightness magnification is increased to increase the number of sustain pulses, thereby increasing a peak brightness of a display image.

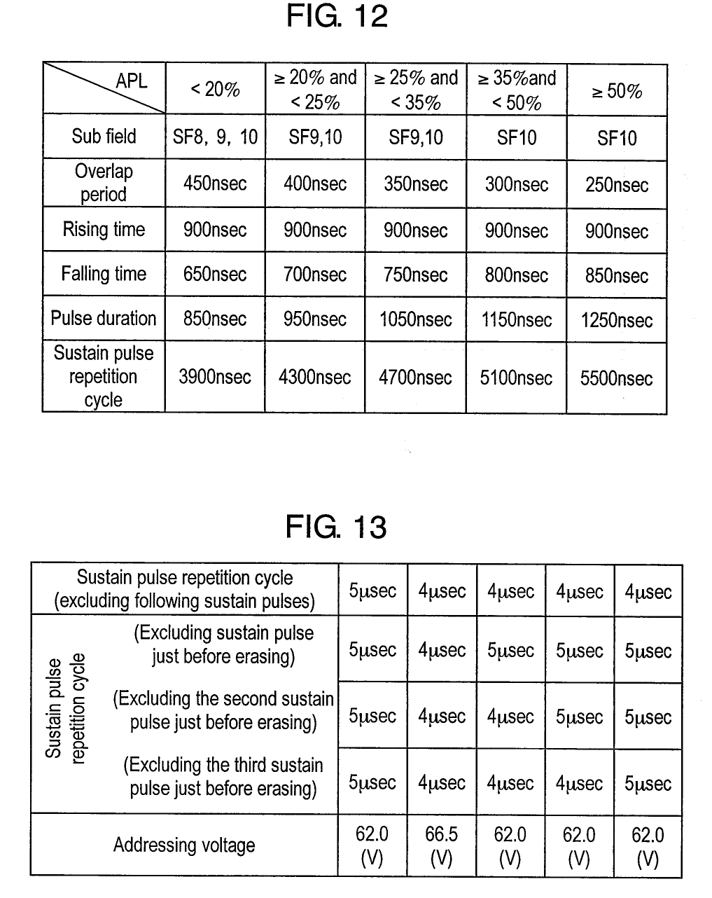

FIG. 12 is a diagram illustrating the relationship between the APL and the shape of the sustain pulse in the plasma display device according to the present embodiment. In the present embodiment, when displaying an image having an APL less than 20%, the overlap period of the sustain pulse in the 8th SF to the 10th SF is set to 450 nsec, the falling time of the sustain pulse is set to 650 nsec, and the repetition cycle of the sustain pulse is set to 3900 nsec. When displaying an image having an APL equal to or greater than 20% and less than 25%, the overlap period of the sustain pulse in the 9th SF and the 10th SF is set to 400 nsec, the falling time of the sustain pulse is set to 700 nsec, and the repetition cycle of the sustain pulse is set to 4300 nsec. When displaying an image having an APL equal to or greater than 25% and less than 35%, the overlap period of the sustain pulse in the 9th SF and the 10th SF is set to 350 nsec, the falling time of the sustain pulse is set to 750 nsec, and the repetition cycle of the sustain pulse is set to 4700 nsec. When displaying an image having an APL equal to or greater than 35% and less than 50%, the overlap period of the sustain pulse in the 10th SF is set to 300 nsec, the falling time of the sustain pulse is set to 800 nsec, and the repetition cycle of the sustain pulse is set to 5100 nsec. When displaying an image having an APL equal to or greater than 50%, the overlap period of the sustain pulse in the 10th SF is set to 250 nsec, the falling time of the sustain pulse is set to 850 nsec, and the repetition cycle of the sustain pulse is set to 5500 nsec. With this configuration, it is possible to increase the brightness magnification as much as 4.3 times.

As described above, in the present embodiment, when displaying an image having a low APL, the repetition cycle of the sustain pulse of a sub field having a large brightness weight is reduced. Additionally, by making the most of the reduced driving time, the brightness magnification is increased to increase the number of sustain pulses, thereby increasing a peak brightness of a display image. The reduced driving time may be utilized for the case of increasing the number of display gradations to improve an image display quality or for the case of increasing the overall cell initializing operation to further stabilize the discharge.

However, when the repetition cycle of the sustain pulse is simply reduced to decrease the pulse duration of the sustain pulse, it is necessary to set address pulse voltage Vd to a high value in order to securely generate the address discharge. This can be thought that the wall voltage formed on the data electrode by the erasing discharge in period T12 of FIG. 7 becomes insufficient and thus it is necessary to raise address pulse voltage Vd in order to supplement the insufficiency in the address period. As a result of investigation to lower address voltage Vd, the present inventors found that by increasing the pulse duration of the sustain pulse for generating the sustain discharge immediately before the erasing discharge, i.e., period T9 in FIG. 7, it is possible to return the address pulse voltage to the original one.

FIG. 13 is a diagram illustrating the experiment results obtained when investigating the relationship between the repetition cycle and the pulse duration of the sustain pulse and the address voltage Vd required for securely generating the address discharge. In this way, when the repetition cycle of the sustain pulse is reduced from 5 μsec to 4 μsec, the address voltage is increased from 62 V to 66.5 V. However, even when the repetition cycle of the sustain pulse is set to 4 μsec, by increasing the pulse duration of the sustain pulse immediate before the erasing discharge to 1000 μsec and increasing the repetition cycle of the sustain pulse to 5 μsec or more, it is possible to return the address voltage to 62 V. It can be found that even when the pulse duration of the second or the third sustain pulse just before the erasing discharge is increased in addition the sustain pulse just before the erasing discharge, the address voltage is not further decreased. Therefore, in order to lower the address pulse voltage, the pulse duration of the sustain pulse just before the erasing discharge should be increased. That is, the sustain pulse for generating the sustain discharge just before the final sustain discharge in the sustain period is set to a sustain pulse other than a sustain pulse having the shortest repetition period. In other words, the repetition period of the sustain pulse for generating the sustain discharge just before the final sustain discharge in the sustain period is longer than the repetition period of at least one of other sustain pulses. However, if there is a margin in the driving time, the pulse duration of the second or the third sustain pulse just before the final sustain pulse may be increased. Thus, the repetition period of the sustain pulse for generating the sustain discharge just before the final sustain discharge in the sustain period may be set to 5 μsec or more. Furthermore, the repetition period of a sustain pulse for generating a second sustain discharge before the final sustain discharge in the sustain period may be set to 5 μsec or more.

Needless to say, sustain pulse voltage Vs should be high enough to securely generate the sustain discharge. Moreover, as described above in connection with the operations of power recovery section 110 and power recovery section 210 with reference to FIG. 6, it is preferable to set sustain pulse voltage Vs to such a low value that the discharge current is distributed. When voltage Vs is too high, a strong sustain discharge is generated between period T2 and period T5 in which the sustain pulses are applied to scan electrode 22 or sustain electrode 23 using power recovery section 110 and power recovery section 210, and thus a large discharge current flows. Since the impedance of power recovery section 110 and power recovery section 210 is high, the flow of a large discharge current causes a voltage drop to greatly lower the voltage applied to scan electrode 22 or sustain electrode 23, thereby making the sustain discharge unstable. Thus, there is a fear of deteriorating an image display quality such as uneven light emission brightness in a display region.

In the present embodiment, sustain pulse voltage Vs is set to 190 V. This voltage value itself is not particularly a low value compared with the sustain pulse voltage of a general plasma display device. However, in panel 10 used in the present embodiment, the light emission efficiency is improved by increasing a partial pressure ratio of xenon to 10%. For this reason, the discharge start voltage between the display electrode pairs is also increased. Therefore, the value of sustain pulse voltage Vs is relatively smaller than the discharge start voltage. That is, during period T2 and period T5 in which voltages are applied to the display electrode pairs using power recovery section 110 and power recovery section 210, the sustain discharge is not generated. Even when the sustain discharge is generated, the voltage applied to the display electrode pairs is lowered by the voltage drop caused by the discharge current so that the generated sustain discharge is not strong enough to make the sustain discharge unstable.

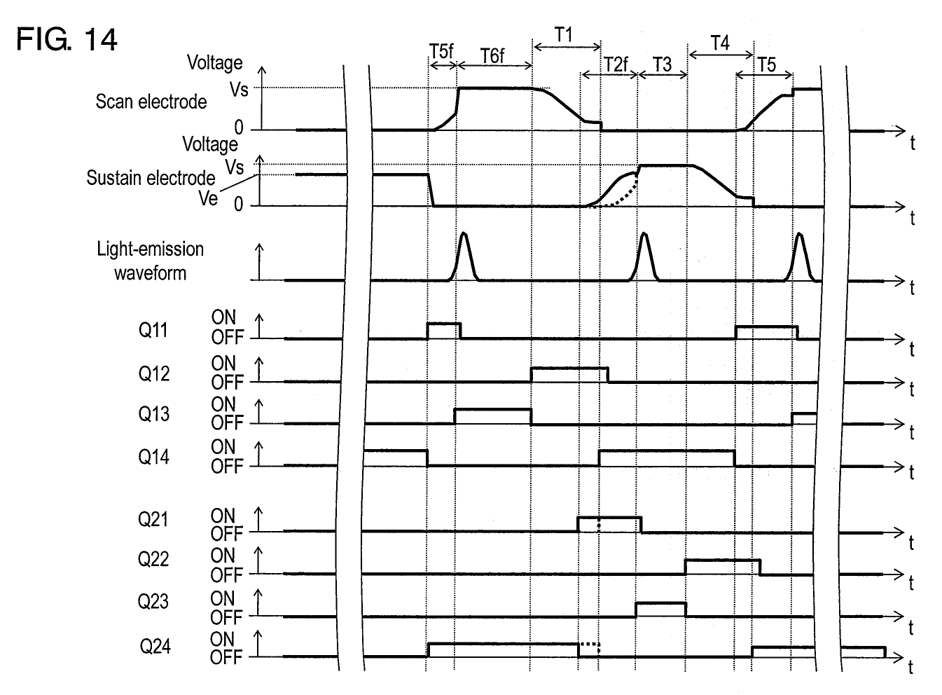

In this way, in the present embodiment, it is possible to increase the light emission efficiency as described above. However, the sustain pulse voltage is set relatively smaller than the discharge start voltage. For this reason, when the wall voltage is securely formed in the sustain discharge, the wall voltage is insufficient and there is a fear that the sustain discharge is not continuously generated. In particular, when the discharging characteristics of the discharge cells that form a display screen is uneven, such a problem is highly likely to occur. Therefore, the rising time of the first sustain pulse may be set so as to be shorter than the rising time of the other sustain pulses so that sufficient wall charges can be securely accumulated in the first sustain discharge in the sustain period. FIG. 14 is a diagram illustrating an example of driving voltage waveforms applied to the electrodes of panel 10 in another embodiment. In this example, period T5f, i.e., the rising time of the first sustain pulse is set to 500 nsec. In this way, by setting the rising time of the first sustain pulse so as to be shorter than period T5, i.e., than the rising time of a normal sustain pulse, a strong sustain discharge is generated, allowing the wall voltage to be securely formed. Thus, in panels in which the discharging characteristics of the discharge cells are uneven, it is possible to continuously generate a stable sustain discharge. In addition, within the range in which the power consumption is not greatly increased, sustain pulses in which the rising time is set short may be inserted at predetermined intervals.

As described above, in the embodiments of the invention, the rising time of the sustain pulse, i.e., the length of period T2 and period T5 has been described as being set to 900 nsec. However, the length of period T2 and period T5 only needs to be equal to or shorter than half the repetition cycle, and the length of time twice the length of period T2 and period T5 only needs to be longer than the length of period T3 and period T6, i.e., than the pulse duration of the sustain pulse.

In the present embodiment, overlap periods in which period T2 and period T5, i.e., the rising time of the sustain pulse and period T1 and period T4, i.e., the falling time of the sustain pulse overlap with each other are provided. However, in the invention, these overlap periods are not necessarily provided.

In the present embodiment, the configuration in which different inductors are used for power supplying purpose and power recovery purpose was described. However, the invention is not limited to such a configuration, and a configuration in which the same inductors are used for power supplying purpose and power recovery purpose may be employed.

In the present embodiment, the length of period T1 and period T4, i.e., the falling time of the sustain pulse is set so as to be shorter than the length of period T2 and period T5, i.e., than the rising time of the sustain pulse. However, the invention does not necessarily need to satisfy such a requirement.

In the present embodiment, the repetition cycle of the sustain pulse has been described as being controlled on the basis of the APL of an image signal. However, the invention does not necessarily need to control the repetition cycle of the sustain pulse.

In the present embodiment, the partial pressure ratio of xenon in the discharging gas is set to 10%, but the driving voltage can be set according to the corresponding panel at other partial pressure ratios of xenon.

The specific numerical values used in the present embodiment are for illustrative purposes only and are preferably, and suitably set to optimal values depending on the characteristics of a panel and the specifications of a plasma display device.

### INDUSTRIAL APPLICABILITY

The plasma display device and the driving method of the plasma display panel according to the invention can further reduce the power consumption while increasing the brightness of a panel and are useful as a high-precision, large-screen plasma display device and the driving method of a plasma display panel.

1. A plasma display device including a plurality of discharge cells, each discharge cell having a display electrode pair including a scan electrode and a sustain electrode, and
a field being formed of a plurality of sub fields, each sub field having an address period in which an address discharge is selectively generated in the discharge cells and a sustain period in which a sustain discharge is generated by applying a sustain pulse by the number of times corresponding to a brightness weight, the plasma display device comprising:
a sustain pulse generating circuit having:
a power recovery section for raising or lowering the sustain pulse by allowing an inter-electrode capacitor of the display electrode pair and an inductor to resonate; and
a clamp section for clamping a voltage of the sustain pulse to a predetermined voltage,
wherein the sustain pulse generating circuit sets a rising time period of a sustain pulse for generating a sustain discharge just before a final sustain discharge in the sustain period to be shorter than that of at least one of other sustain pulses and sets the sustain pulse for generating the sustain discharge just before the final sustain discharge in the sustain period to a sustain pulse other than a sustain pulse having the shortest repetition period.

2. The plasma display device of claim 1,
wherein the sustain pulse generating circuit sets a repetition period of the sustain pulse for generating the sustain discharge just before the final sustain discharge in the sustain period to 5 μsec or more.

3. The plasma display device of claim 1,
wherein the sustain pulse generating circuit sets a pulse duration of the sustain pulse for generating the sustain discharge just before the final sustain discharge in the sustain period to 1000 nsec or more.

4. The plasma display device of claim 2,
wherein the sustain pulse generating circuit sets a repetition period of a sustain pulse for generating a second sustain discharge before the final sustain discharge in the sustain period to 5 μsec or more.

5. A plasma display device comprising:
a plasma display panel having a plurality of discharge cells, each discharge cell having a display electrode pair formed of a scan electrode and a sustain electrode; and
a sustain pulse generating circuit for generating a sustain discharge by applying a sustain pulse to the display electrode pairs,
wherein the sustain pulse generating circuit sets a rising time period of a sustain pulse for generating a sustain discharge just before a final sustain discharge in the sustain period to be shorter than that of at least one of other sustain pulses and sets a repetition period of the sustain pulse for generating the sustain discharge just before the final sustain discharge in a sustain period to be longer than the repetition period of at least one of other sustain pulses.

6. A plasma-display-panel driving method in which one field includes a plurality of sub fields, each sub field having an address period in which an address discharge is selectively generated in discharge cells and a sustain period in which a sustain discharge is generated by applying a sustain pulse by the number of times corresponding to a brightness weight, the method comprising:
raising or lowering the sustain pulse by allowing an inter-electrode capacitor of a display electrode pair including a scan electrode and a sustain electrode and an inductor to resonate; and
clamping a voltage of the sustain pulse to a predetermined voltage,
wherein a rising time period of a sustain pulse for generating a sustain discharge just before a final sustain discharge in the sustain period is set to be shorter than that of at least one of other sustain pulses and the sustain pulse for generating a sustain discharge just before the final sustain discharge in the sustain period is set to a sustain pulse other than a sustain pulse having the shortest repetition period.
